(19) United States
(12) Patent Application Publication
(10) Pub. No.: US 2020/0360796 A1
(43) Pub. Date: Nov. 19, 2020

(54) BASE ROBOT

(71) Applicant: SZ DJI TECHNOLOGY CO., LTD., Shenzhen (CN)

(72) Inventor: Xiaobin YU, Shenzhen (CN)

(21) Appl. No.: 16/984,523

(22) Filed: Aug. 4, 2020

Related U.S. Application Data
(63) Continuation of application No. PCT/CN2018/109025, filed on Sep. 30, 2018.

(30) Foreign Application Priority Data
Feb. 5, 2018 (CN) 201820200383.0

(51) Int. Cl. A63B 71/06; B25J 9/00; B25J 9/14; B25J 11/00

(52) U.S. Cl. CPC A63B 71/0669; B25J 11/003; B25J 9/144; B25J 9/0009

(57) ABSTRACT

The present disclosure provides a base robot. The robot includes a base; a multi-piece housing movably mounted on the base covering a part of the base when the housing is closed, and exposing the base when the housing is opened; and a driving assembly connecting the base and the housing, and driving the housing to move relative to the base, and opening or closing the housing.

### CROSS-REFERENCE TO RELATED APPLICATIONS

This application is a continuation of International Application No. PCT/CN2018/109025, filed on Sep. 30, 2018, which claims priority to Chinese Patent Application No. 201820200383.0, filed on Feb. 5, 2018, the entire contents of all of which are incorporated herein by reference.

### TECHNICAL FIELD

The present disclosure relates to the field of robots and, more specifically, to a base robot.

### BACKGROUND

With the advancement of technology, various smart devices have emerged in recent years. Among these smart devices, robots have been adapted in various industries. In order to promote the research and development of robots, various confrontational robot competitions have been organized locally and internationally.

In confrontational robot competitions, the base robot, as a robot to determine the outcomes of the competitions, plays a vital role in the competitions. As such, extensive researches have been devoted to improve the viewing pleasure of base robots in competitions.

### SUMMARY

The present disclosure provides a base robot. The robot includes a base; a multi-piece housing movably mounted on the base covering a part of the base when the housing is closed, and exposing the base when the housing is opened; and a driving assembly connecting the base and the housing, and driving the housing to move relative to the base, and opening or closing the housing.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a perspective view of a base robot in which a housing of the base robot is closed according to an embodiment of the present disclosure.

FIG. 2 is a perspective view of another state of the base robot shown in FIG. 1, in which the housing is half opened.

FIG. 3 is a perspective view of yet another state of the base robot shown in FIG. 1, in which the housing is fully opened.

FIG. 4 is a plane view of the base robot shown in FIG. 1 when the housing is closed.

FIG. 5 is a plane view of the base robot shown in FIG. 1 when the housing is fully opened.

FIG. 6 is an exploded perspective view of the housing and a driving assembly of the base robot shown in FIG. 1.

FIG. 7 is a cross-sectional view of the housing and the driving assembly shown in FIG. 6 when the housing is closed.

FIG. 8 is a cross-sectional view of the housing and the driving assembly shown in FIG. 6 when the housing is half opened.

FIG. 9 is a cross-sectional view of the housing and the driving assembly shown in FIG. 6 when the housing is fully opened.

FIG. 10 is a block diagram of a control module of the base robot according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Reference will now be made in detail to exemplary aspects of the present disclosure, examples of which are illustrated in the accompanying drawings. The following description refers to the accompanying drawings in which the same numbers in different drawings represent the same or similar elements unless otherwise represented. The implementations set forth in the following description of exemplary aspects do not represent all implementations consistent with the present disclosure. Instead, they are merely examples of apparatuses and methods consistent with aspects related to the present disclosure as recited in the appended claims.

The terminologies used herein are only for describing particular aspects but not for limiting the present disclosure. The singular form words “a,” “the,” and “said” used in the present disclosure and append claims are intended to include plural form, unless otherwise clearly stated. In addition, it shall be appreciated that the terminology “and/or” used herein refers to any or all combinations of one or more listed related items.

It should be understood that in the present disclosure, the term and/or as used herein refers to and includes one or more possible combinations of one or more associated listed terms. Unless otherwise noted, the terms “front,” “back” (or “rear”), “lower,” and/or “upper” and other similar terms are only for the convenience of descriptions, and are not intended to limit to a particular position, location, or space orientation. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. In addition, the terms “plurality,” “multiple” and other similar terms refer to two or more.

The base robot in the embodiment of the present disclosure includes a base, a multi-piece housing, and a driving assembly. The multi-piece housing is movably mounted on the base. The multi-piece housing covers at least a part of the base when the housing is closed, and exposes the base when the housing is open. The driving assembly connects the base and the housing, and the driving assembly moves relative to the base to open or close the housing. The multi-piece housing is movably mounted on the base of the base robot, and the housing can be closed or opened. The housing can be opened during the robot competition, which may improve the viewing pleasure of the robot competition.

The base robot of the present disclosure will be described in detail below with reference to the drawings. The features in the following examples and embodiments can be combined with each other when there is no conflict.

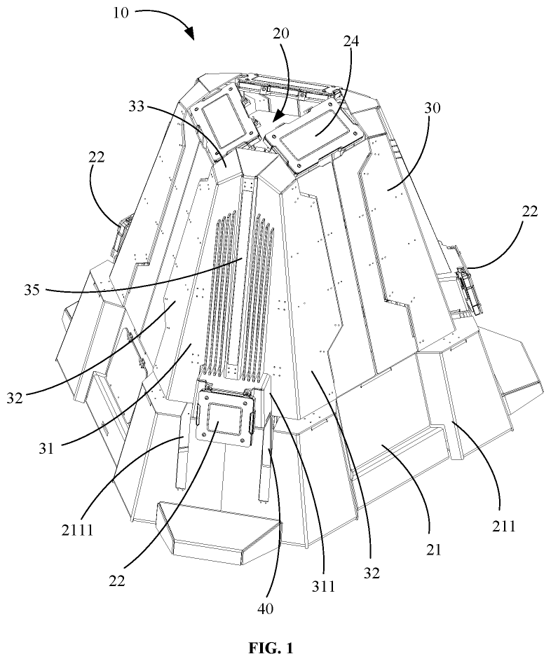

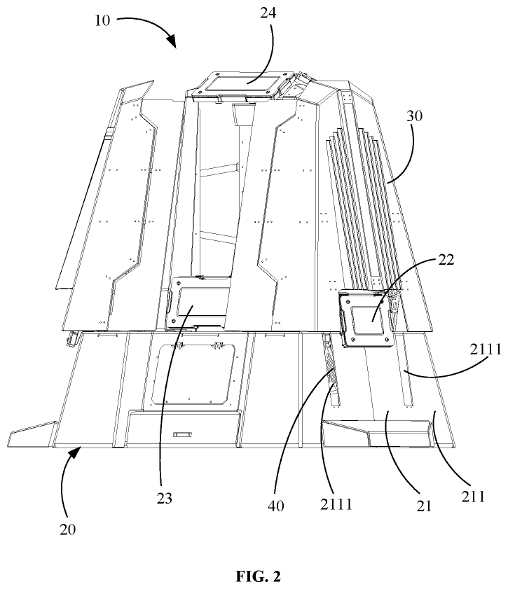

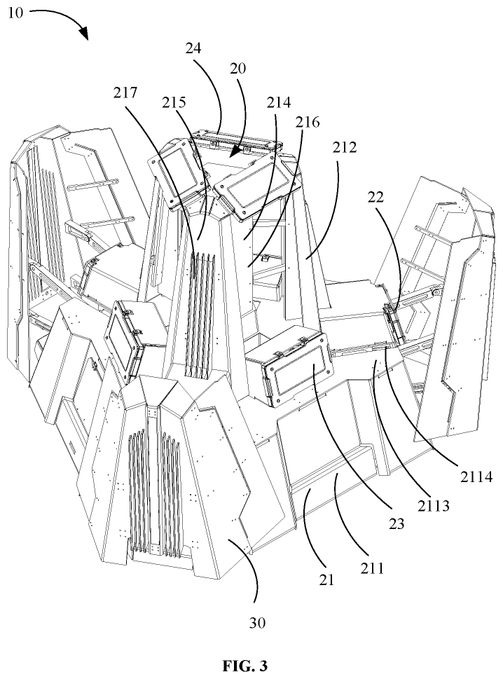

FIG. 1 is a perspective view of a base robot 10 according to an embodiment of the present disclosure. The base robot 10 includes a base body 20, a multi-piece housing 30 movably mounted on the base body 20, and a driving assembly 40 connecting the base body 20 and the housing 30. The housing 30 may include a closed state and an open state. The driving assembly 40 may drive the housing 30 to move relative to the base body 20 such that the housing 30 may be opened or closed. The multi-piece housing 30 in FIG. 1 is closed, covering at least a part of the base body 20. The open state of the housing 30 may include a half-open state and a full-open state. FIG. 2 is a perspective view of the base robot 10 when the housing 30 is half opened, and FIG. 3 is a perspective view the base robot 10 when the housing 30 is fully opened.

Referring to FIGS. 1-3, the base body 20 includes a base 21, a first armor 2 disposed on the base 21, and a second armor 23 disposed on the base 21. The base 21 includes a base 211 and a protruding tower 212 protruding above the base 211. In some embodiments, the height of the base 211 may be lower than the height of the protruding tower, the cross section of the base 211 may be larger than the protruding tower, and the protruding tower may protrude upward from the middle of the base 211.

In the illustrated embodiment, a longitudinally extending side slot 211 is disposed on the side of the base 211, and the side slot 2111 is in communication with an internal space of the base 211. The base 211 includes a top plate 2113. A top plate slot 2114 is disposed on the top plate 2113 corresponding to the position of the side slot 2111. The top plate slot 2114 extends laterally from the bottom end near the protruding tower 212 to the side of the base 211. The top plate slot 2114 is in communication with the internal space of the base 211, and communicates with the side slot 2111 at the junction of the side surface of the base 211 and the top plate 2113. The side slot 2111 and the top slot 2114 allow the driving assembly 40 to protrude from the inside of the base 211. The driving assembly 40 can move in the side slot 2111 and the top slot 2114 to drive the housing 30 to move. In some embodiments, two laterally spaced side slots 2111 may be formed on the same side of the base 211, and the two spaced top plate slots 2114 corresponding to the two side slots 2111 may be formed on the top plate 2113.

In some embodiments, the base 211 may be in the form of a boss whose cross section gradually increases from top to bottom, and the side surface of the base 211 may extend obliquely. In some embodiments, the cross section of the base 211 may be substantially polygonal. The side slot 2111 may be formed on multiple sides of the base 211 facing different directions. In some embodiments, a control device, a power supply device, and/or other devices can be disposed in the base 211.

In the illustrated embodiment, the protruding tower 212 may include a central convex frame 214 and a plurality of side frames 215 arranged around the central convex frame 214. The plurality of side frames 215 may be spaced apart from the central convex frame 214, and the plurality of side frames 215 may be spaced apart from each other. The side frames 215 may extend obliquely downward and outward from the top of the convex frame 214. In other embodiments, the protruding tower 212 may include other structures.

In some embodiments, a baes health indicator light 216 may be mounted on the base 21. The base health indicator light 216 can be used to indicate the health of the base robot 10. The higher the height of the base health indicator light 216, the more the health, and the lower the height of the base health indicator light 216, the less the health. In some embodiments, the base health indicator light 216 can flash to create the breathing effect of the base robot 10. In the illustrated embodiment, the base health indicator light 216 may be mounted on the central convex frame 214 of the protruding tower 212, and the central convex frame 214 can support the base health indicator light 216. The base health indicator light 216 may be in the shape of a light box and disposed vertically. In addition, at least a part of the base health indicator light 216 may be exposed between the plurality of side frames 215.

In some embodiments, an auxiliary indicator light 217 may be mounted on the base 21. In some embodiments, the auxiliary indicator light 217 may be used to display health, form a central cylindrical light effect, create a breathing effect, and/or reflect other information or effects, etc. In some embodiments, the auxiliary indicator light 217 may be mounted on the side frames 215 of the protruding tower 212. The auxiliary indicator light 217 may take the form of a long strip, and a plurality of strips that are spaced apart may be mounted on the side frames 215.

The first armor 22 may be mounted on the base 211 of the base 21. The first armor 22 may be disposed between two side slots 2111 on the same side of the base 211. The first armor 22 may be exposed outward from the side of the base 211. In the illustrated embodiment, the lower portion of the first armor 22 may protrude into the side of the base 211, and the upper portion may protrude above the top plate 2113 of the base 211. In another embodiment, the first armor 22 may be disposed on the side of the base 211. In yet another embodiment, the first armor 22 may be disposed above the top plate 2113.

The second armor 23 may be mounted on the base 211 of the base 21. As shown in FIG. 3, the second armor 23 may be mounted on the top plate 2113 of the base 211 and disposed near the center of the base 211 relative to the first armor 22. The second armor 23 may be disposed at the bottom of the protruding tower 212 between the adjacent side frames 215. The projections of the second armor 23 and the first armor 22 in the horizontal plane may be staggered from each other. In the illustrated embodiment, the second armor 23 and the first armor 22 respectively correspond to adjacent sides of the base 211.

The first armor 22 and the second armor 23 may be targets that can be hit by the opposing robot and/or other robots. The more the hits, the less the health the base robot 10. In some embodiments, the base body 20 may include a plurality of first armors 22 and a plurality of second armors 23. In addition, the projections of the second armor 23 and the first armor 22 on the base 211 may be arranged on a ring at intervals. The plurality of first armors 22 and second armors 23 may face different directions. As such, the base robot 10 may be hit from multiple directions. In some embodiments, the base body 20 may include three or more first armors 22 and three or first armors 23. In the illustrated embodiment, the base body 20 includes three first armors 22 and three second armors 23, but is not limited thereto. In some embodiments, the surface of the first armor 22 to be hit may be smaller than the surface of the second armor to be hit.

In some embodiments, the base body may include a third armor 24 mounted on the top of the base 21, and the third armor 24 may be disposed on top of the base health indicating light 216. The third armor 24 may be mounted on top of the protruding tower 212. In some embodiments, the base body 20 may include a plurality of third armors 24 arranged on top of the base 21. In some embodiments, the base body 20 may include three or more third armors 24 arranged in a ring shape on top of the base 21. In the illustrated embodiment, three third armors 24 are provided, but is not limited thereto. In addition, in the illustrated embodiment, the third armor 24 is extending obliquely downward and outward.

As shown in FIG. 1, when the multi-piece housing 30 is closed, at least a part of the base body 20 and the second armor 23 are covered, and the first armor 22 is exposed outside the housing 30. The first armor 20 may expose from the bottom of the housing 30. When the housing 30 is closed, the first armor 22 can be hit, and the second armor 23 is protected by the housing and cannot be hit. The protruding tower 212 may cover the base 21 when the housing 30 is closed, and the housing 30 may be disposed above the base 211. In some embodiments, when the housing 30 is closed, the third armor 24 may be exposed on the top of the housing 30 and can be hit.

When the housing 30 is closed, a plurality of housings may surround the base 21, and the adjacent housings 40 may be connected. In some embodiments, the three or more housings 30 may be provided. In the illustrated embodiment, three housings 30 are provided. The plurality of housings 30 may have the same or different shapes. In the illustrated embodiment, the shapes of the three housings 30 are substantially the same. The housing 30 may include a base plate 31 and a connecting plate 32 extending from the side of the base plate 31 at an angle to the base plate 31. The connecting plate 32 may extend toward the adjacent housing 30 and connect with the connecting plate 32 of the adjacent housing 30 when the housing is closed.

When the housing 30 is closed, the base plate 31 may be disposed above the side of the base 211 with the side slot 2111, and the base plate 31 may extend obliquely upward and inward. In some embodiments, the slope of the base plate 31 relative to the bottom surface of the base 211 may be substantially the same as the slope of the corresponding side surface of the base 211 relative to the bottom surface. In some embodiments, the first armor 22 may be exposed from the bottom of the base plate 31. A notch 311 may be formed at the bottom of the base plate 31, and at least a part of the first armor 22 may be exposed from the notch 311.

The connecting plate 32 may extend on the opposite side of the base plate 31 in the longitudinal direction, and the pair of connecting plates 32 may be arranged symmetrically with respect to the base plate 31. In the illustrated embodiment, the opening of the pair of connecting plates 32 gradually expands from the base plate 31 in a direction away from the base plate 31, and the shapes of the two connecting plates 32 are substantially the same. In another embodiment, the shapes of the two connecting plates 32 may be substantially different. In the illustrated embodiment, when the housing 30 is closed, the connecting plate 32 extends obliquely upward and inward, and the connecting plate 32 and the base plate 31 are located above the adjacent side surfaces of the base 211. In some embodiments, the slope of the connecting plate 32 relative to the bottom surface of the base 211 may be substantially the same as the slope of the corresponding side surface of the base 21 relative to the bottom surface. In addition, the connecting plates of the two adjacent housings 30 may be roughly connected on the centerline of the side surface of the base 211.

The housing 30 may include a top cover 33 formed at the top of the base plate 31 and the connecting plate. The top cover 33 may be at an angle to the base plate 31, and at an angle to the connecting plate 32. When the housing 30 is closed, the top cover 33 may extend obliquely into the base 21 at the top of the base 21 to cover at least a part of the top of the base 21. In some embodiments, the top cover 33 may cover the space between the adjacent third armors 24. In some embodiments, the base plate 31, the connecting plate 32, and the top cover 33 may be integrally formed.

A housing health indicator light 35 may be mounted on the housing 30. The housing health indicator light 35 may be used to indicate the health of the base robot 10. The higher the height of the light, the more the health, and vice versa. In some embodiments, the housing health indicator light 35 on the housing can also flash to create a breathing effect or other lighting effects. When the housing 30 is closed, the housing health indicator light 35 may extend longitudinally above the first armor 22. The more the hits the first armor 22 receives, the less the health the housing health indicator light 35 may display.

As shown in FIGS. 2 and 3, the second armor 23 is exposed when the housing is opened. The second armor 23 may be disposed at the connecting position of the adjacent housing 30. When the housing 30 is opened, the housing 30 may translate and rotate relative to the base body 20. The housing 30 can be translated to the half-open state shown in FIG. 2, and then rotated downward and outward to the full-open state shown in FIG. 3. When the housing 30 is opened, the second armor 23 can receive hit. The more hits the second armor 23 receives, the less health the baes health indicator light 216 may display. When the housing 30 is fully opened, the base body 20 may be substantially exposed and may be easily hit.

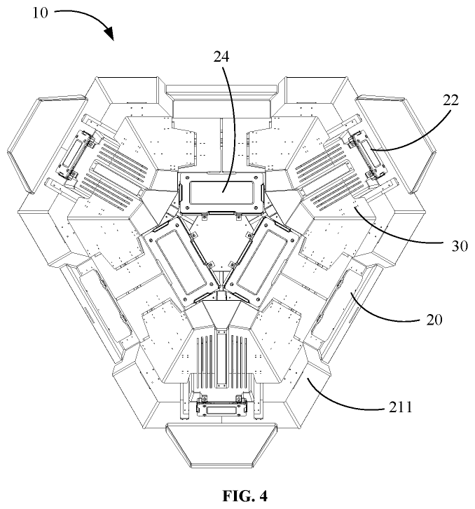

FIG. 4 is a plane view of the base robot shown in FIG. 1 when the housing is closed. The projection of the base robot 10 in the horizontal plane is substantially an equilateral triangle. The projection of the base 211 in the horizontal plane is substantially a hexagon, with three long sides and three short sides, where the long sides and the shorts side are adjacent to each other. The line connecting the centers of the three first armors 22 is an equilateral triangle. The three third armors 24 are arranged along the three sides of the equilateral triangle.

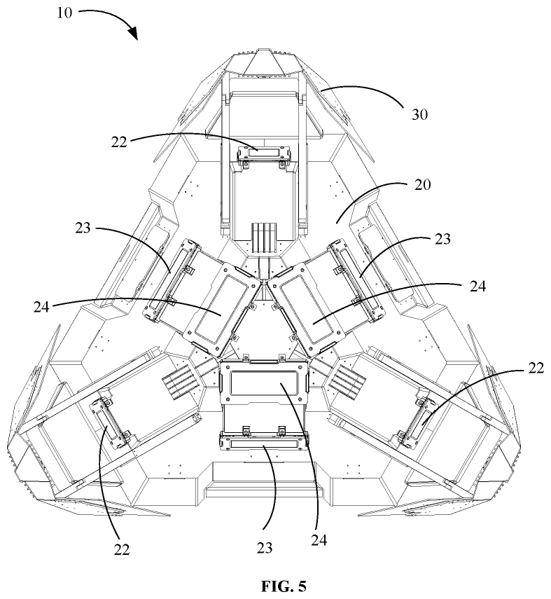

FIG. 5 is a plane view of the base robot shown in FIG. 1 when the housing is fully opened. The line connecting the midpoints of the three second armors 23 is an equilateral triangle. The third armor 24 corresponds to the second armor 23, and the third armor 24 and the corresponding second armor 23 face the same side. In addition, the first armor 22 and the second armor 23 are staggered.

FIGS. 4 and 5 are merely examples of the embodiments of the present disclosure, but not limited to the examples shown in FIGS. 4 and 5. In other embodiments, the shape and structure of the base robot 10, the base body 20, the base 211, the housing 30, the number of the housing 30, the position, distribution, number, etc. of the first armor 22, the second armor 23, and the third armor 24 may be designed to be different from the embodiments in the figures.

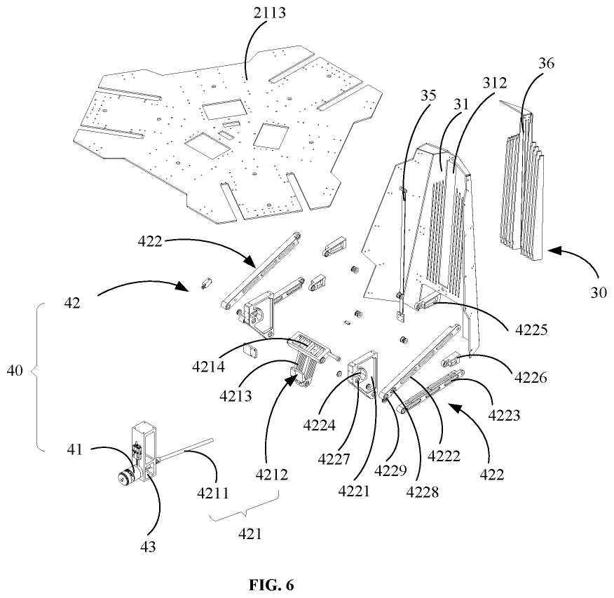

FIG. 6 is an exploded perspective view of the housing 30 and the driving assembly 40. The housing 30 includes a light cover 36, which is mounted on the base plate 31. A light mounting groove 214 is longitudinally disposed in the middle of the base plate 31, and the housing health indicator light 35 is mounted in the light mounting groove 312. The light cover 36 covers the housing health indicator light 35 from the outside of the base plate 31, and the light cover 36 can protect the housing health indicator light 35 and can transmit light.

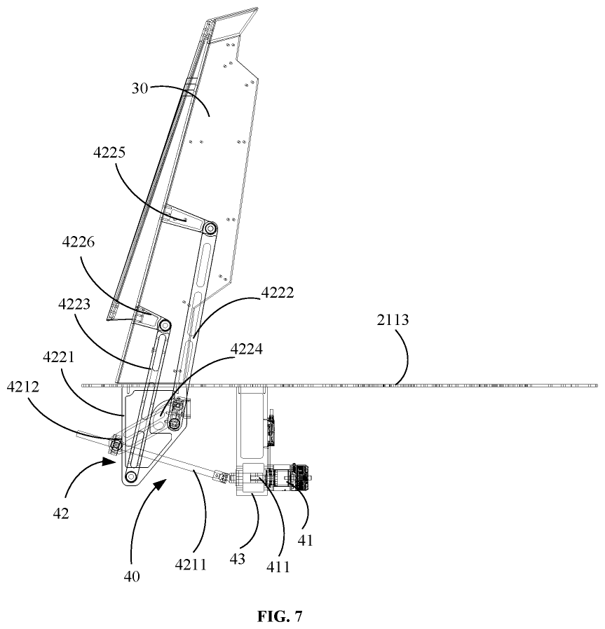

FIG. 7 is a cross-sectional view of the housing 30 and the driving assembly 40 when the housing is in a closed state. Referring to FIGS. 6 and 7, the driving assembly 40 includes a driving device 41 and a transmission mechanism 42 connected to the driving device 41. The driving device 41 drives the transmission mechanism 42 to move, and the transmission mechanism 42 is connected to the housing 30 to drive the housing 30 to move.

The driving device 41 may include a steering gear, a motor, a hydraulic driving device, and/or other driving devices. The driving device 41 can be energized to generate a driving force to drive the transmission mechanism 42 to move. In some embodiments, the driving device 41 may be fixedly mounted on the top plate 2113 of the base 211 through a fixed mounting member 43. The driving device 41 may be disposed in the base 211, the fixed mounting member 43 may be fixedly connected to the bottom surface of the top plate 2113, and the driving device 41 may be mounted below the top plate 2113. In another embodiment, the driving device 41 may be fixedly mounted at other positions of the base 21.

The transmission mechanism 42 may be connected to the base plate 31 of the housing 30. The transmission mechanism 42 may include a main transmission assembly 421 connected to the driving device 41, and a pair of connecting rod assemblies 422 connected to opposite sides of the main transmission assembly 421. The driving device 41 may drive the main transmission assembly 421 to move, and the main transmission assembly 421 may drive the connecting rod assembly 422 to move. The connecting rod assembly 422 may be connected to the housing 30 to drive the housing 30 to move.

In some embodiments, the main transmission assembly 421 may include a screw 4211 connected to the driving device 31 and a rotating member 4212 connected to the screw 4211. The screw 4211 may drive the rotating member 4212 to rotate, and the rotating member 4212 may be connected to the connecting rod assembly 422 to drive the connecting rod assembly 422 to move. The screw 4211 may be fixedly connected to a power output shaft 411 of the driving device 41, and the driving device 41 may drive the screw 4211 to move through the power output shaft 411. In some embodiments, the screw 4211 may extend at an angle to the power output shaft 411 of the driving device 41. The direction of extension of the screw 4211 and the power output shaft 411 may not be on the same straight line. The power output shaft 411 may rotate, driving the screw 4211 to rotate around the conical surface.

The bottom of the rotating member 4212 may be movably connected to the screw 4211, and the screw 4211 may pass through the bottom of the rotating member 4212. The top of the rotating member 4212 may be connected to the connecting rod assembly 422. The screw 4211 may rotate, such that the bottom of the rotating member 4212 may move along the screw 4211, and the top of the rotating member 4212 may rotate, driving the connecting rod assembly 422 to move. The rotating member 4212 may include a screw connecting part 4213 and a connecting rod connecting part 4214 at the top of the screw connecting part 4213. The screw connecting part 4213 may extend longitudinally, the connecting rod connecting part 4214 may extend laterally, and both ends of the connecting rod connecting part 4214 may extend beyond the screw connecting part 4213.

In another embodiment, the main transmission assembly 421 may include gears, racks, cams, worm gears, and/or other transmission components.

The connecting rod assembly 422 includes a bracket 4221, a first connecting rod 4222, and a second connecting rod 4223. The bracket 4221 may be fixed to the base 21. In the illustrated embodiment, the bracket 4221 is fixed to the bottom surface of the top plate 2113, as shown in FIG. 7. A movable guide groove 4224 may be formed on the bracket 4221. In some embodiments, the movable guide groove 4224 may extend in an arc shape. The movable guide groove 4224 may be a groove with a closed edge, and penetrates the opposite sides of the bracket 4221. In some embodiments, the movable guide groove 4224 may be an arc shape with a length of substantially one-quarter of a circle. In other embodiments, the length of the movable guide groove 4224 can be designed based on the maximum distance that the housing 30 is expected to move.

The first connecting rod 4222 may be connected to the main transmission assembly 421 through the bracket 4221, and the main transmission assembly 421 may drive the first connecting rod 4222 to move relative to the bracket 4221. The first connecting rod 4222 and the main transmission assembly 421 may be connected through the movable guide groove 4224, and the main transmission assembly 421 may drive one end of the first connecting rod 4222 to move along the movable guide groove 4224. The first connecting rod 4222 may be hinged to the connecting rod connecting part 4214 of the main transmission assembly 421.

The first connecting rod 4222 may be hinged to the bracket 4221. The part of the first connecting rod 4222 hinged to the bracket 4221 may be closer to the end of a first end than the part of the first connecting rod 4222 hinged to the rotating member 4212. A first hinge hole 4228 may be formed on the first connecting rod 4222, corresponding to movable guide groove 4224. A second hinge hole 4229 may also be formed on the first connecting rod 4222, which may be closer to the end of the first end relative to the first hinge hole 4228. The second hinge hole 4229 may correspond to a hinge position 4227 on the bracket 4221.

The rotating member 4212 may be hinged to the bracket 4221. The connecting rod connecting part 4214 of the rotating member 4212 may be hinged to the bracket 4221, and the hinged position may be relative to the hinge position 4227 of the first connecting rod 4222. The first connecting rod 4222 and the rotating member 4212 may be hinged to opposite sides of the bracket 4221, respectively. The hinge position 4227 may be disposed inside the arc-shaped movable guide groove 4224. The hinge position 4227 may be approximately at the center of the circle where the arc-shaped movable guide groove 4224 is located.

The second connecting rod 4223 may be hinged to the bracket 4221. The hinge of the second connecting rod 4223 and the bracket 4221 may be disposed obliquely below the hinge position 4227 of the first connecting rod 4222 and the bracket. The second connecting rod 4223 may be disposed below the first connecting rod 4222, and the length of the second connecting rod 4223 may be less than the length of the first connecting rod 4222.

The connecting rod assembly 422 may include a first connector 4225 connecting the first connecting rod 4222 and the housing 30, and a second connector 4226 connecting the second connecting rod 4223 to the housing 30. The first connector 4225 may be hinged to the first connecting rod 4222, and the second connecting rod 4223 may be hinged to the second connecting rod 4223. The first connector 4225 may be hinged to a second end of the first connecting rod 4222 relative to the first end. The second connector 4226 may be hinged to the end of the second connecting rod 423 away from the bracket 4221. The first connector 4225 and the second connector 4226 may be fixedly connected to the inner side of the base plate 31 of the housing 30. The length of the first connector 4225 may be greater than the length of the second connecting rod 4223.

As shown in FIG. 7, when the housing 30 is closed, the screw 4211 extends obliquely upward, the bottom of the rotating member 4212 is away from the driving device 41, and the top of the rotating member 4212 is located laterally of the movable guide groove 4224 and close to the inner end of the driving device 41. The end of the first connecting rod 4222 hinged to the rotating member 4212 is located at the inner end of the movable guide groove 4224. The first connecting rod 4222 and the second connecting rod 4223 extend upward from the base plate 31, and pull the housing 30 inward through the first connector 4225 and the second connector 4226. In some embodiments, when the housing 30 is closed, the first connecting rod 4222 and the second connecting rod 4223 may extend obliquely upward and inward. The first connector 4225 may be substantially perpendicular to the first connecting rod 4222, and the second connector 4226 may be substantially perpendicular to the second connecting rod 4223.

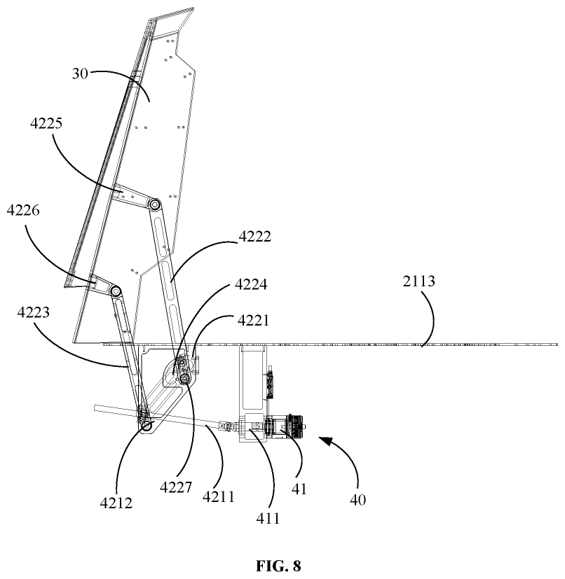

FIG. 8 is a cross-sectional view of the housing 30 and the driving assembly 40 when the hosing 30 is half opened. Compared with the closed state shown in FIG. 7, the power output shaft 41 of the driving device 41 in FIG. 8 rotates, driving the screw 4211 to rotate, and the slope of the screw 4211 extending upward and downward becomes less steep. The bottom of the rotating member 4212 may move toward the driving device 41. The top of the rotating member 4212 may rotate relative to the bracket 4221 at the hinge position 4227 of the bracket 4221. The connection between the top and the first connecting rod 4222 may move along the movable guide groove 4224 away from the inner end, driving the first connecting rod 4222 to move along the movable guide groove 4224, and approximately moving to the middle of the movable guide groove 4224. The first end of the first connecting rod 4222 may rotate relative to the bracket 4221 at the hinge position 4227 of the bracket 4221.

The first connecting rod 4222 and the second connecting rod 4223 may extend upward from the top plate 2113. The second end of the first connecting rod 4222 and the end of the second connecting rod 4223 away from the bracket 4221 may rotate outward, and the end of the second connecting rod 4223 hinges to the bracket 4221 may rotate relative to the bracket 4221. The housing 30 may be pushed outward by the first connector 4225 and the second connector 4226, and the housing 30 may translate outward on the top plate 2113. At this time, the first connecting rod 4222 and the second connecting rod 4223 may extend obliquely upward and outward. The angle between the first connector 4225 and the first connecting rod 4222 may increase, which can be greater than 90°. In addition, the angle between the second connector 4226 and the second connecting rod 4223 may increase, which can be greater than 90°.

FIG. 9 is a cross-sectional view of the housing 30 and the driving assembly 40 when the housing 30 is fully opened. Compared with the half-open state of FIG. 8, the power output shaft 411 of the driving device 41 in FIG. 9 continues to rotate, driving the screw 4311 to rotate, such that the screw 4211 may extend obliquely downward. The bottom of the rotating member 4212 further moves toward the driving device 41, and is closer to the driving device 41. The top of the rotating member 4212 may rotate relative to the bracket 4221 at the hinge position 4227 of the bracket 4221, and the connection between the top and the first connecting rod 4222 may move away from the inner end along the movable guide groove 4224, which can drive the first connecting rod 4222 to move along the movable guide groove 4224 to the outer end of the movable guide groove 4224 relative to the inner end. In addition, the first end of the first connecting rod 4222 may rotate relative to the bracket 4221 at the hinge position 4227 of the bracket 4221.

As shown in FIG. 3, the first connecting rod 4222 and the second connecting rod 4223 are extending outward from the side of the base 211. The second end of the first connecting rod 4222 and the end of the second connecting rod 4223 away from the bracket 4221 may continue to rotate outward, and the end of the second connecting rod 4223 hinged to the bracket 4221 may rotate relative to the bracket 4221. The housing 30 may move outward and rotate by the first connector 4225 and the second connector 4226. The angle between the first connector 4225 and the first connecting rod 4222 may increase. In addition, the angle between the second connector 4226 and the second connecting rod 4223 may also increase, which can be approximately 180°.

The power output shaft 411 of the driving device 41 may rotate in one direction, and the closed housing 30 may be opened. Further, the power output shaft 411 of the driving device 41 may rotate in the opposite direction, and the opened housing 30 may be closed. The screw 4211 may rotate from extending downward with an inclination to upward with the inclination. The bottom of the rotating member 4212 may move in a direction from being close to the driving device 41 to away from the driving device 41. The top of the rotating member 4212 may move in a direction from the outer end to the inner end of the movable guide groove 4224, driving the first end of the first connecting rod 4222 to move. The ends of the first connecting rod 4222 and the second connecting rod 4223 that are away from the bracket 4221 may rotate upward and inward. The first connector 4225 and the second connector 4226 may pull the housing 30 to rotate and translate inward, thereby closing the housing 30.

During the competition, the housing 30 of the base robot 10 can be opened under certain conditions, and the shape of the base robot 10 may change to make the competition more enjoyable. The transmission mechanism 42 can be driven by the driving device 41 to realize the translation and rotation movement of the housing 30, and the translation and rotation movement can be realized by a power source with higher efficiency.

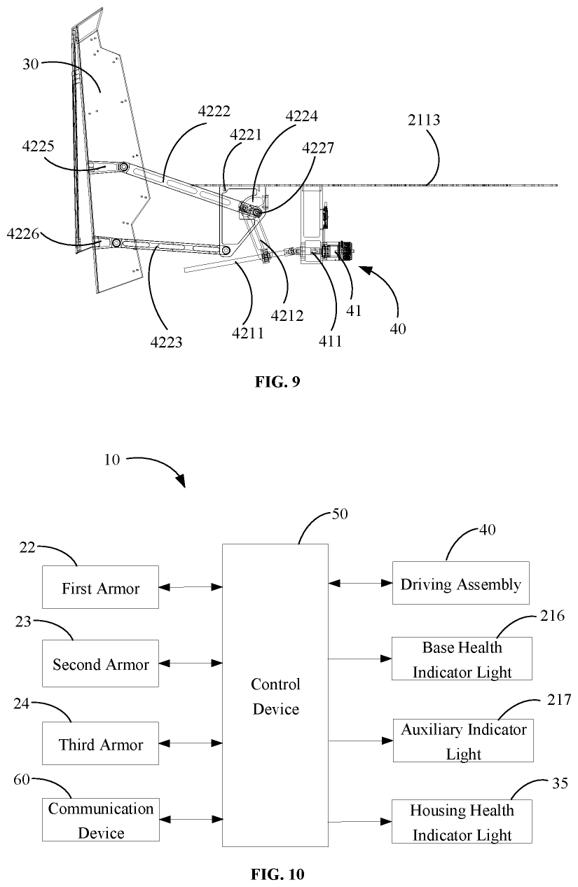

FIG. 10 is a block diagram of a control module of the base robot 10 according to an embodiment of the present disclosure. The base robot 10 may include a control device 50. The control device 50 may be configured to control the driving assembly 40 to drive the housing 30 to open when a housing opening condition is met. The control device 50 may be configured to control the driving assembly 40 to open or close the housing 30. Further, the control device 50 may be electrically connected to the driving device 41 of the driving assembly 40 to control the operation of the driving device 41, such that the driving assembly 40 may be controlled to open or close the housing 30.

The control device 50 may be configured to control whether the first armor 22, the second armor 23, and the third armor 24 can accept hits. On one hand, when the first armor 22, the second armor 23, and the third armor 24 is accepting hits, the armors may sense an external hit signal and generate a corresponding electrical signal to the control device 50. On the other hand, when the first armor 22, the second armor 23, and the third armor 24 stop accepting hits, if the armors sense an external hit signal, the corresponding electrical signal may not be generated. The armor 22, the second armor 23, and the third armor 24 may include sensors for sensing external hits and generating the corresponding electrical signals. The control device 50 may be configured to control whether the sensors are enabled or disabled.

The control device 50 may be configured to control the base health indicator light 216, the auxiliary indicator light 217, the housing health indicator light 35 to light or flash. The control device 50 may be configured to control the housing health indicator light 35 based on the degree of impact and/or position where the first armor 22 is hit, and control the base health indicator light 216 and the auxiliary indicator light 217 based on the degree of impact and/or position where the second armor 23 is hit. In some embodiments, the control device 50 may control the housing health indicator light 35 based on the degree of impact and/or position where the first armor 22 and the third armor 24 are hit. The hits received by the first armor 22 and third armor 24 may have different effect on the health loss of the base robot 10. For example, the third armor 24 receives one hit, and the base robot 10 may lose more health. In another embodiment, the control device 50 may control the base health indicator light 216 and/or the auxiliary indicator light 217 based on the degree of impact and/or position where the second armor 23 and the third armor 24 are hit. In addition, the control device 50 may be disposed in the base 211 of the base robot 10, and the control device 50 may include a microprocessor such as a single chip microcomputer.

The base robot 10 may include a communication device 60, such as a wireless communication device, which can communicate with other robots. For example, the base robot 10 can communicate with a sentry robot through the communication device 60 to acquire the state of the sentry robot. More specifically, the control device 50 can communicate with the control device of the sentry robot through the communication device 60, receive signals from the sentry robot, and send signals to the sentry robot, etc. In some embodiments, the communication device 60 can also be used for other aspects of communications.

The control method provided in the embodiments of the present disclosure can be used to control a base robot. The base robot may include a base body, a multi-piece housing movably mounted on the base body, and a driving assembly connecting the base body and the housing. The control method can control the base robot 10 described above, and the control device 50 can execute the control method.

The control method may include controlling the driving assembly to drive the housing to open relative to the base body when the housing opening condition is met. In addition, the driving device of the driving assembly can be controlled to control the driving assembly.

In some embodiments, the control method may include acquiring state information of an interactive robot, and controlling the opening and closing state of the housing based on the state information of the interactive robot. The state information of the interactive robot can be acquired through the communication device 60. The interactive robot may include, but is not limited to, a sentry robot. In some embodiments, the state information may include the degree of impact received by the interactive robot. When the degree of impact received by the interactive robot reached a certain threshold, the driving assembly may be controlled to open the housing. In some embodiments, the control method may include acquiring a signal of the degree of impact received by the interactive robot, and controlling the driving assembly to open the housing when the degree of impact signal reaches a first degree of impact threshold.

In some embodiments, the driving assembly may be controlled to drive the housing to be fully opened when the degree of impact received by the interactive robot reaches the first degree of impact threshold. In another embodiment, the driving assembly may be controlled to drive the housing to be half opened when the degree of impact received by the interactive robot reaches a value lower than the first degree of impact threshold. When the degree of impact received by the interactive robot exceeds the first degree of impact threshold, the driving assembly may be controlled to drive the housing to be fully opened.

In some embodiments, the control method may include controlling the first armor to be able to accept hits, and acquiring the signal of the degree of impact received by the first armor. When the degree of impact reaches a second degree of impact threshold, the driving assembly may be controlled to open the housing. When the housing is closed, the first armor may be controlled to be able to accept hits. In some embodiments, when the degree of impact received by the first armor reaches the second degree of impact threshold, the driving assembly may be controlled to drive the housing to be fully opened. In another embodiment, when the degree of impact received by the first armor reaches a value lower than the second degree of impact threshold, the driving assembly may be controlled to drive the housing to be half opened. When the degree of impact received by the first armor reaches a value higher than the second degree of impact threshold, the driving assembly may be controlled to drive the housing to be fully opened.

In some embodiments, when one of the conditions of the degree of impact received by the first armor reaches the second degree of impact threshold, or the degree of impact signal reaches the first degree of impact threshold is met, the driving assembly may be controlled to open the housing. In another embodiment, when both conditions of the degree of impact received by the first armor reaches the second degree of impact threshold, and the degree of impact signal reaches the first degree of impact threshold are met, the driving assembly may be controlled to open the housing.

In some embodiments, the control method may include controlling the second armor to accept hits after the housing is opened. After the housing is opened, the second armor may be exposed, the second armor may be controlled to be enabled. In some embodiments, after the housing is opened, the first armor may be controlled to stop accepting hits.

In some embodiments, the control method may include controlling the third armor to accept hits under certain conditions. In some embodiments, the third armor may be controlled to accept hits when the housing is closed. The third armor may accept hits at the same time as the first armor. Alternatively, when the degree of impact received by the first armor reaches a certain value, the third armor may be controlled to start accepting hits. Alternatively, after the first armor receives hits for a period of time, the third armor may be controlled to start accepting hits. In another embodiment, after the housing is opened, the third armor may be controlled to accept hits. The control of the third armor can be designed based on the actual application, which is not limited to the above examples.

For the method embodiments, reference may be made to the relevant parts of the description of the device embodiments. In addition, the method embodiment may complement the device embodiment.

It should be noted that the relationship terms used in the text of this application, such as first and second, are only for distinguishing an object or operation from another object or operation, but not for defining or implying any practical relation or order between the object or operation. The terms “include”, “contain” or other alternatives shall be non-exclusiveness, the inclusion of a series of element such as process, method, object or equipment shall include not only the already mentioned elements but also those elements not mentioned, and shall include the elements which are inherent in the process, method, object or equipment. However, under the condition of no more limitations, the definition of an essential element limited by the sentence “including a . . . ” shall not obviate that in addition to containing the said essential element in the process, method, object or equipment, other essential element of the same nature may also exist in the above-mentioned process, method, object or equipment.

The method and device provided in embodiments of the present disclosure have been described in detail above. In the present disclosure, particular examples are used to explain the principle and embodiments of the present disclosure, and the above description of embodiments is merely intended to facilitate understanding the methods in the embodiments of the disclosure and concept thereof; meanwhile, it is apparent to persons skilled in the art that changes can be made to the particular implementation and application scope of the present disclosure based on the concept of the embodiments of the disclosure, in view of the above, the contents of the specification shall not be considered as a limitation to the present disclosure.

What is claimed is:

1. A base robot, comprising:
a base;
a multi-piece housing movably mounted on the base covering a part of the base when the housing is closed, and exposing the base when the housing is opened; and
a driving assembly connecting the base and the housing, driving the housing to move relative to the base, and opening or closing the housing.

2. The base robot of claim 1, further comprising:
a first armor disposed on the base, the first armor is exposed outside the housing when the housing is closed.

3. The base robot of claim 1, further comprising:
a second armor disposed on the base, the second armor is covered when the housing is closed, and the second armor is exposed when the housing is opened.

4. The base robot of claim 1, wherein:
the driving assembly includes a driving device and a transmission mechanism, the transmission mechanism is connected to the driving device, the driving device drives the transmission mechanism, and the transmission mechanism is connected to the housing to drive the housing.

5. The base robot of claim 4, wherein:
the transmission mechanism includes a main transmission assembly connected to the driving device and a pair of connecting rod assemblies connected to opposite sides of the main transmission assembly, the driving device drives the main transmission assembly, the main transmission assembly drives the connecting rod assemblies, and the connecting rod assemblies are connected to the housing to drive the housing.

6. The base robot of claim 5, wherein:
the connecting rod assembly includes a bracket, a first connecting rod, and a second connecting rod, the bracket is fixedly mounted on the base, the first connecting rod is connected to the main transmission assembly, through the bracket, the main transmission assembly drives the first connecting rod to move relative to the bracket, and the second connecting rod is hinged to the bracket.

7. The base robot of claim 6, wherein:
a movable guide groove is formed on the bracket, and the first connecting rod and the main transmission assembly are connected through the movable guide groove, the main transmission assembly drives one end of the first connecting rod to move along the movable guide groove.

8. The base robot of claim 7, wherein:
the movable guide groove extends in an arc shape.

9. The base robot of claim 6, wherein:
the connecting rod assembly includes a first connector connecting the first connecting rod and the housing and a second connector connecting the second connecting rod and the housing, the first connector is hinged to the first connecting rod, and the second connector is hinged to the second connecting rod.

10. The base robot of claim 5, wherein:
the main transmission assembly includes a screw connected to the driving device and a rotating member connected to the screw, the screw drives the rotating member to rotate, the rotating member is connected to the connecting rod assembly to drive the connecting rod assembly.

11. The base robot of claim 10, wherein:
the screw extends at an angle to the power output shaft of the driving device.

12. The base robot of claim 1, wherein:
the housing includes a base plate and a connecting plate extending from a side of the base plate at an angle to the base plate, the connecting plate extends toward an adjacent housing and connects with the connecting plate of the adjacent housing when the housing is closed.

13. The base robot of claim 1, further comprising:
a third armor mounted on top of the base, a base health indicator light is mounted on the base, and the third armor is disposed on top of the base health indicator light.

14. The base robot of claim 1, further comprising:
a control device configured to control the driving assembly to drive the housing to open when a housing opening condition is met.

15. A control method for controlling a base robot, the base robot comprising a base body; a multi-piece housing movably mounted on the base body; and a driving assembly connecting the base body and the housing; the control method comprising:
controlling the driving assembly to drive the housing to open relative to the base body when the housing opening condition is met.

16. The control method of claim 15, comprising:
acquiring state information of an interactive robot; and
controlling the opening and closing state of the housing based on the state information of the interactive robot.

17. The control method of claim 16, comprising:
acquiring a signal of degree of impact received by the interactive robot; and
controlling the driving assembly to open the housing when the signal of the degree of impact reaches a first degree of impact threshold.

18. The control method of claim 15, wherein a first armor disposed on the base, the first armor is exposed outside the housing when the housing is closed, the method comprising:
receiving hits on the first armor;
acquiring the signal of degree of impact received by the first armor; and
controlling the driving assembly to open the housing when the signal of the degree of impact reaches a second degree of impact threshold.

19. The control method of claim 18, wherein a second armor disposed on the base, the method comprising:
receiving hits on the second armor when the housing is open; and
acquiring the signal of the degree of impact received by the second armor.

20. The control method of claim 18, wherein a third armor is disposed on top of the base, the method comprising:
receiving hits on the third armor when the housing is closed.
